(19) United States
(12) Patent Application Publication
(10) Pub. No.: US 2016/0192427 A1
(43) Pub. Date: Jun. 30, 2016

(54) OPERATION METHOD OF COMMUNICATION NODE IN WIRELESS COMMUNICATION NETWORK

(71) Applicant: ELECTRONICS AND TELECOMMUNICATIONS RESEARCH INSTITUTE, Daejeon (KR)

(72) Inventors: Mi Young Yun, Daejeon (KR); Ae Soon Park, Daejeon (KR); Chul Sik Yoon, Daejeon (KR); Kyoung Seok Lee, Daejeon (KR)

(73) Assignee: ELECTRONICS AND TELECOMMUNICATIONS RESEARCH INSTITUTE, Daejeon (KR)

(21) Appl. No.: 14/985,059

(22) Filed: Dec. 30, 2015

(30) Foreign Application Priority Data
Dec. 30, 2014 (KR) 10-2014-0193805
Aug. 13, 2015 (KR) 10-2015-0114912
Sep. 25, 2015 (KR) 10-2015-0136619

(51) Int. Cl. H04W 76/02; H04L 12/18

(52) U.S. Cl. CPC H04W 76/023; H04W 76/021; H04L 12/18

(57) ABSTRACT

Disclosed are operation methods of a terminal in a wireless communication network. An operation method of a terminal in a communication network may comprise configuring a layer-2 ID of the terminal which is used for device-to-device (D2D) communications for a transmission manner; and performing the D2D communications by using the layer-2 ID. Therefore, performance of the communication network can be enhanced.

### CROSS-REFERENCE TO RELATED APPLICATIONS

This application claims priorities to Korean Patent Application No. 10-2014-0193805 filed on Dec. 30, 2014, Korean Patent Application No. 10-2015-0114912 filed on Aug. 13, 2015, and Korean Patent Application No. 10-2015-0136619 filed on Sep. 25, 2015 in the Korean Intellectual Property Office (KIPO), the entire contents of which are hereby incorporated by reference.

### BACKGROUND

1. Technical Field

The present invention relates to wireless communication technologies, and more particularly, to operation methods of a terminal in device-to-device communications.

2. Related Art

In a cellular communication network, a user equipment (UE) may generally transmit and receive a data unit through a base station. For example, when a data unit to be transmitted to a second UE exits, a first UE may generate a frame including the data unit to be transmitted to the second UE, and transmit the generated frame to a first base station to which the first UE belongs. The first base station may receive the frame from the first UE, and identify that a destination of the received frame is the second UE. The first base station may transmit the frame to a second base station to which the second UE, as the identified destination, belongs. The second base station may receive the frame from the first base station, and identify that the destination of the received frame is the second UE. The second base station may transmit the frame to the second UE as the identified destination. The second UE may receive the frame from the second base station, and obtain the data unit included in the received frame.

Meanwhile, device-to-device (D2D) communications may mean that a UE communicates directly with another UE. For example, when a data unit to be transmitted to the second UE exists, the first UE may generate a frame including the data unit to be transmitted to the second UE, and directly transmit the generated frame to the second UE. The second UE may receive the frame from the first UE, and obtain the data unit included in the received frame.

Here, an ID of a terminal performing D2D communications (hereinafter, referred to as ‘D2D terminal’ or ‘D2D UE’) may be configured by a higher layer (e.g., a base station, a communication network, a communication system, etc.). However, in a case that the ID of the D2D terminal is not configured by the higher layer or the ID configured by the higher layer is not a globally unique ID, a method for configuring the ID of the D2D terminal is demanded.

### SUMMARY

Accordingly, exemplary embodiments of the present invention are provided to substantially obviate one or more problems due to limitations and disadvantages of the related art.

Exemplary embodiments of the present disclosure provide methods for configuring an ID of a terminal in D2D communications.

Also, exemplary embodiments of the present disclosure provide methods for acquiring an ID of an opposite terminal in D2D communications.

In order to achieve the objectives of the present disclosure, an operation method of a terminal in a communication network may be provided. The method may comprise configuring a layer-2 identifier (ID) of the terminal which is used in device-to-device (D2D) communications for a transmission manner; and performing the D2D communications by using the layer-2 ID.

Here, when the transmission manner is a unicast transmission, the layer-2 ID may be used as a source address and a destination address.

Here, the layer-2 ID may have a size of 24 bits.

Here, when the transmission manner is a multicast transmission, the layer-2 ID may be used as a source address, and a predetermined multicast ID may be used as a destination address.

Here, when the transmission manner is a broadcast transmission, the layer-2 ID may be used as a source address, and a predetermined broadcast ID may be used as a destination address.

Here, the layer-2 ID may be configured within a range determined according to each transmission manner.

Here, a frame transmitted from the terminal in the D2D communications may include an indicator indicating the transmission manner of the frame. Also, the indicator may be a layer-1 ID, and the layer-1 ID may be included in a preamble of the frame. Also, the indicator may be a logical channel identity (LCID), and the LCID may be configured according to the transmission manner of the frame. Also, the indicator may be a logical channel identity (LCID), and the LCID may be configured according to the transmission manner of the frame. Also, the indicator may be included in a medium access control (MAC) header of the frame. In addition, the MAC header may further include information indicating whether the indicator exists in the MAC header or not.

Here, the method may further comprise receiving a mapping information between a priority of traffic and a logical channel group identity (LCGID) from a base station. In addition, the mapping information may be received through dedicated signaling.

In order to achieve the objectives of the present disclosure, an operation method of a first terminal in a communication network may be provided. The method may comprise receiving a frame including a layer-2 ID of a second terminal from the second terminal; configuring a session for device-to-device (D2D) communications by using the layer-2 ID of the second terminal; and performing the D2D communications with the second terminal through the session.

Here, the layer-2 ID may be configured for unicast based D2D communications, and the layer-2 ID may be used as a source address and a destination address.

Here, the frame may further include an indicator indicating at least one service supported by the second terminal.

In order to achieve the objectives of the present disclosure, another operation method of a first terminal in a communication network may be provided. The method may comprise transmitting a first frame including a layer-2 ID of the first terminal and an indicator indicating at least one service supported by the first terminal; receiving a second frame including a layer-2 ID of a second terminal from the second terminal, in response to the first frame; configuring a session for device-to-device (D2D) communications by using the layer-2 ID of the second terminal; and performing the D2D communications with the second terminal through the session.

Here, the second terminal may support the at least one service indicated by the indicator.

Here, the layer-2 ID may be configured for unicast based D2D communications, and the layer-2 ID may be used as a source address and a destination address.

Here, the method further comprises reconfiguring the layer-2 ID of the first terminal when the second frame indicates that the layer-2 ID of the first terminal is used by another terminal.

According to the exemplary embodiments, the identifier (e.g., the layer-2 identifier) of the terminal can be configured for D2D communications. In this case, the identifier of the terminal can be configured without collisions with identifiers of other terminals. Also, the terminal can announce its identifier, and obtain identifiers of opposite terminals. When the identifier of the terminal is identical to the identifier of other terminal, the terminal can change its identifier. Therefore, the performance of the communication network can be enhanced.

### BRIEF DESCRIPTION OF DRAWINGS

Exemplary embodiments of the present invention will become more apparent by describing in detail exemplary embodiments of the present invention with reference to the accompanying drawings, in which:

FIG. 1 is a conceptual diagram illustrating a first exemplary embodiment of a communication network;

FIG. 2 is a conceptual diagram illustrating a second exemplary embodiment of a communication network;

FIG. 3 is a conceptual diagram illustrating a third exemplary embodiment of a communication network;

FIG. 4 is a conceptual diagram illustrating a fourth exemplary embodiment of a communication network;

FIG. 5 is a block diagram illustrating an exemplary embodiment of a communication node constituting a communication network;

FIG. 6 is a sequence chart illustrating an operation method of a terminal according to an exemplary embodiment of the present disclosure;

FIG. 7 is a block diagram illustrating an exemplary embodiment of a frame used for D2D communications;

FIG. 8 is a block diagram illustrating a SL-SCH sub-header of a frame;

FIG. 9 is a block diagram illustrating a first exemplary embodiment of a MAC PDU sub-header;

FIG. 10 is a block diagram illustrating a second exemplary embodiment of a MAC PDU sub-header;

FIG. 11 is a block diagram illustrating a third exemplary embodiment of a MAC PDU sub-header;

FIG. 12 is a conceptual diagram illustrating IDs used in a communication network;

FIG. 13 is a sequence chart illustrating a method of obtaining an ID of a terminal according to an exemplary embodiment of the present disclosure;

FIG. 14 is a sequence chart illustrating a method of obtaining an ID of a terminal according to another exemplary embodiment of the present disclosure;

FIG. 15 is a sequence chart illustrating a method of preventing collisions between IDs of terminals according to an exemplary embodiment of the present disclosure;

FIG. 16 is a sequence chart illustrating a method of preventing collisions between IDs of terminals according to another exemplary embodiment of the present disclosure;

FIG. 17 is a conceptual diagram illustrating another exemplary embodiment of a communication network;

FIG. 18 is a sequence chart illustrating a method of preventing collisions between IDs of terminals according to yet another exemplary embodiment of the present disclosure; and

FIG. 19 is a sequence chart illustrating a method of preventing collisions between IDs of terminals according to yet another exemplary embodiment of the present disclosure.

### DETAILED DESCRIPTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific example embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in greater detail with reference to the accompanying drawings. In order to facilitate general understanding in describing the present invention, the same components in the drawings are denoted with the same reference signs, and repeated description thereof will be omitted.

A wireless communication network to which exemplary embodiments according to the present discloser applied will be described below. The wireless communication network to which exemplary embodiments according to the present discloser applied is not restricted to following description, and exemplary embodiments according to the present discloser may be applied to various wireless communication networks.

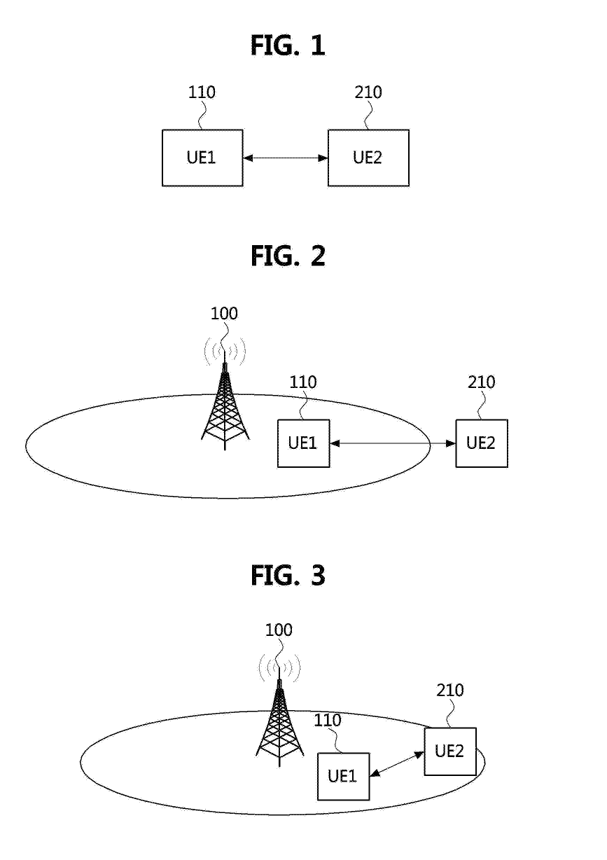

FIG. 1 is a conceptual diagram illustrating a first exemplary embodiment of a communication network.

Referring to FIG. 1, each of a first terminal (e.g., user equipment) 110 and a second terminal 210 may be located outside of a cell coverage of a base station. When the first terminal 110 has a frame to be transmitted to the second terminal 210, the first terminal 110 may directly transmit the frame to the second terminal 210. The first terminal 110 may directly receive a frame from the second terminal 210. That is, each of the first terminal 110 and the second terminal 210 may transmit or receive a frame via D2D communications.

FIG. 2 is a conceptual diagram illustrating a second exemplary embodiment of a communication network.

Referring to FIG. 2, the first terminal 110 may be located within a cell coverage of a first base station 100, and the second terminal 210 may be located outside the cell coverage of the first base station 100. When the first terminal 110 has a frame to be transmitted to the second terminal 210, the first terminal 110 may directly transmit the frame to the second terminal 210. The first terminal 110 may directly receive a frame from the second terminal 210. That is, each of the first terminal 110 and the second terminal 210 may transmit or receive a frame via D2D communications.

FIG. 3 is a conceptual diagram illustrating a third exemplary embodiment of a communication network.

Referring to FIG. 3, each of the first terminal 110 and the second terminal 210 may be located within the cell coverage of the first base station 100. When the first terminal 110 has a frame to be transmitted to the second terminal 210, the first terminal 110 may directly transmit the frame to the second terminal 210. The first terminal 110 may directly receive a frame from the second terminal 210. That is, each of the first terminal 110 and the second terminal 210 may transmit or receive a frame via D2D communications.

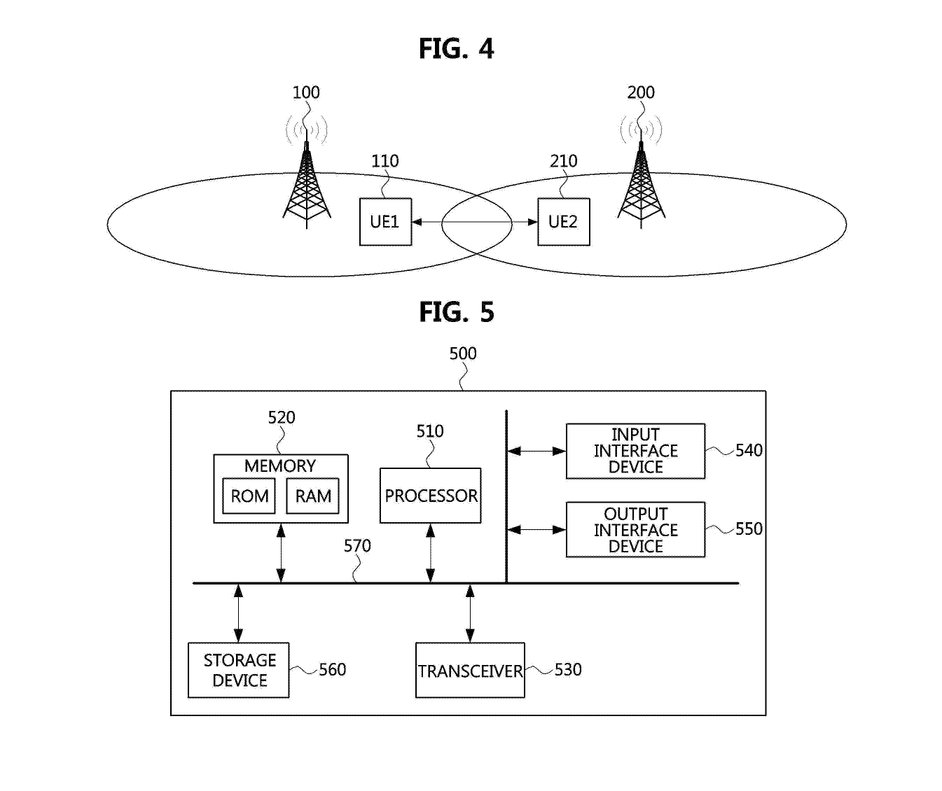

FIG. 4 is a conceptual diagram illustrating a fourth exemplary embodiment of a communication network.

Referring to FIG. 4, the first terminal 110 may be located within the cell coverage of the first base station 100, and the second terminal 210 may be located within a cell coverage of a second base station 200. When the first terminal 110 has a frame to be transmitted to the second terminal 210, the first terminal 110 may directly transmit the frame to the second terminal 210. The first terminal 110 may directly receive a frame from the second terminal 210. That is, each of the first terminal 110 and the second terminal 210 may transmit or receive a frame via D2D communications.

A communication node constituting above-described wireless communication network (e.g., the base station, the terminal) may support a communication protocol based on code division multiple access (CDMA), a communication protocol based on wideband CDMA (WCDMA), a communication protocol based on time division multiple access (TDMA), a communication protocol based on frequency division multiple access (FDMA), a communication protocol based on single carrier-FDMA (SC-FDMA), a communication protocol based on orthogonal frequency division multiplexing (OFDM), a communication protocol based on orthogonal frequency division multiple access (OFDMA), and so on.

The base station of the communication node may be referred to a NodeB, an evolved NodeB, a base transceiver station (BTS), a radio base station, a radio transceiver, an access point, an access node, and so on. The terminal may be referred to a UE, an access terminal, a mobile terminal, a station, a subscriber station, a portable subscriber station, a mobile station, a node, a device, and so on. The communication node may have following structure.

FIG. 5 is a block diagram illustrating an exemplary embodiment of a communication node constituting a communication network.

Referring to FIG. 5, a communication node 500 may include at least one processor 510, a memory 520 and a transceiver 530 connected to a network and performing communication. Further, the communication node 500 may include an input interface device 540, an output interface device 550, and a storage device 560. The respective components included in the communication node 500 may be connected via a bus 570 to communicate with each other.

The processor 510 may perform a program command stored in the memory 520 and/or the storage device 560. The processor 510 may be a central processing unit (CPU), a graphics processing unit (GPU) or a dedicated processor in which the methods according to an exemplary embodiment of the present discloser are performed. The memory 520 and the storage device 560 may include a volatile storage medium and/or a nonvolatile storage medium. For example, the memory 520 may include a read only memory (ROM) and/or a random access memory (RAM).

Operation methods of the communication node in the wireless communication network will be described below. Although a method (e.g., signal transmission or reception) performed by a first communication node will be described, a second communication node corresponding thereto may perform a method (e.g., signal reception or transmission) corresponding to the method performed by the first communication node. That is, when an operation of the first terminal is described, the second terminal (or, the base station) corresponding thereto may perform an operation corresponding to the operation of the first terminal. On the contrary, when an operation of the second terminal (or, the base station) is described, the first terminal may perform an operation corresponding to an operation of the second terminal (or, the base station).

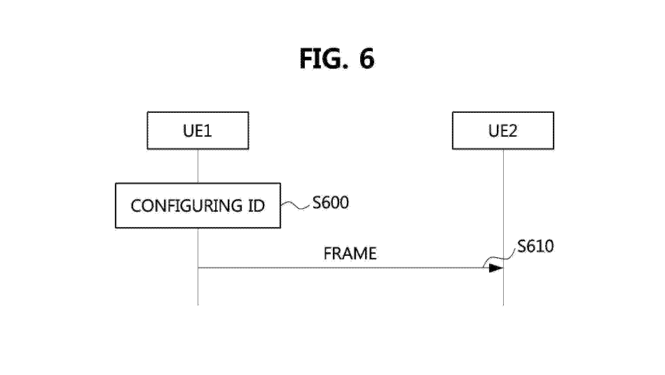

FIG. 6 is a sequence chart illustrating an operation method of a terminal according to an exemplary embodiment of the present disclosure.

Referring to FIG. 6, a first terminal UE1 may be located in a communication range with a second terminal UE2. That is, the UE1 can perform D2D communications with the UE2. Here, the UE1 may be the first terminal 110 explained by referring to FIGS. 1 to 4. The UE2 may be the second terminal 210 explained by referring to FIGS. 1 to 4. Also, the

UE1 and UE2 may be configured as the communication node 500 explained by referring to FIG. 5. When the D2D communications are performed, the UE1 and UE2 may exchange frames with each other. Here, a structure of the frames may be configured as follows.

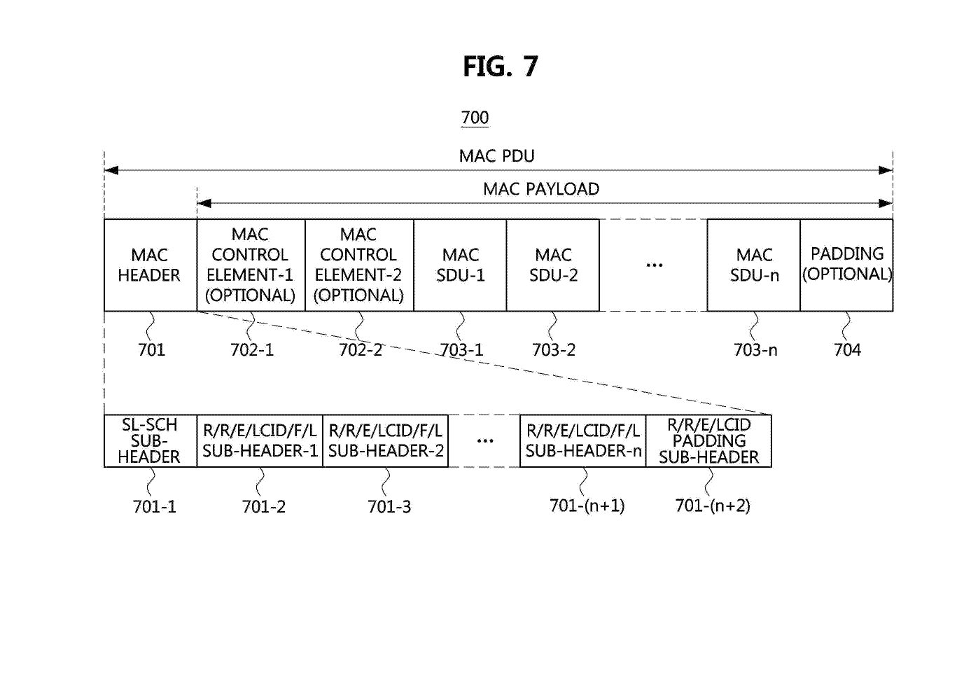

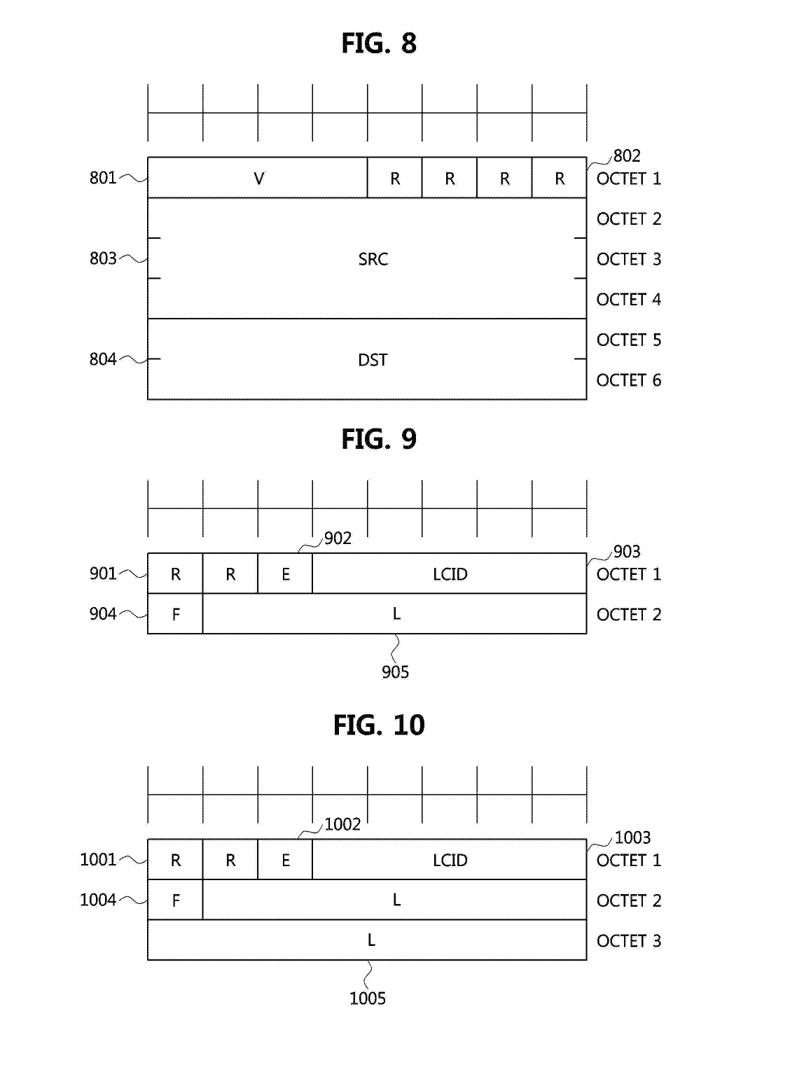

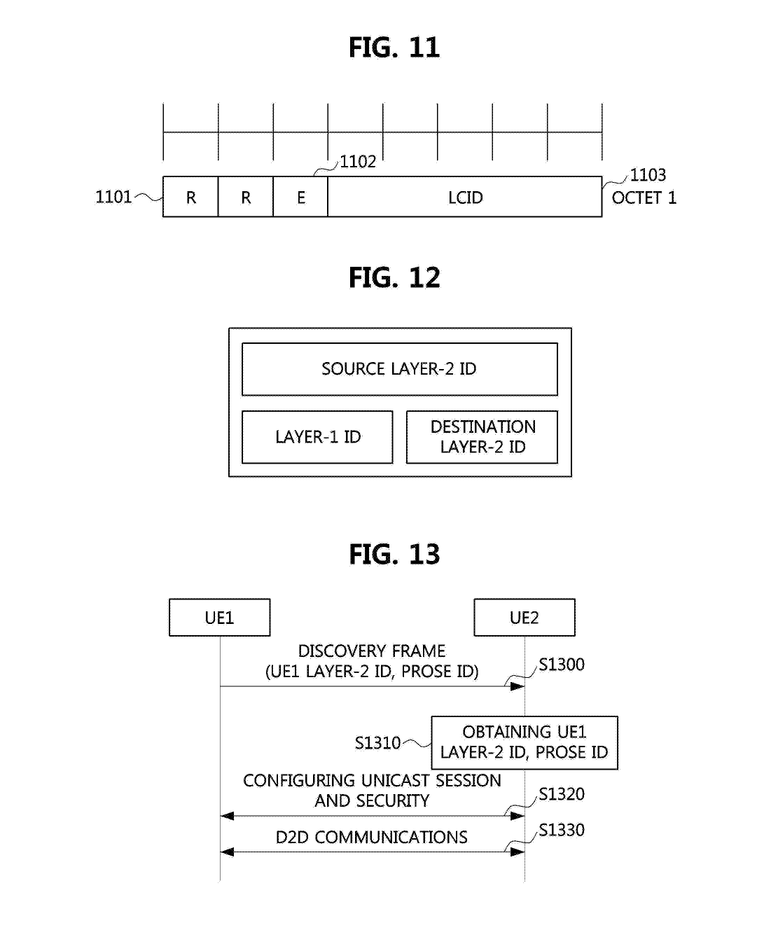

FIG. 7 is a block diagram illustrating an exemplary embodiment of a frame used for D2D communications, FIG. 8 is a block diagram illustrating a sidelink-shared channel (SL-SCH) sub-header of a frame, FIG. 9 is a block diagram illustrating a first exemplary embodiment of a medium access control (MAC) protocol data unit (PDU) sub-header, FIG. 10 is a block diagram illustrating a second exemplary embodiment of a MAC PDU sub-header, and FIG. 11 is a block diagram illustrating a third exemplary embodiment of a MAC PDU sub-header.

Referring to FIGS. 7 to 11, a MAC frame (e.g., MAC PDU) 700 may comprise a MAC header 701 and a MAC payload. The MAC header 701 may comprise a SL-SCH sub-header 701-1, at least one MAC PDU sub-header 701-2, 701-3, . . . , 701-(n+1), and 701-(n+2). A size of the MAC header 701 may be variable. The MAC payload may comprise a plurality of MAC control elements (CE) 702-1 and 702-2, and a plurality of MAC service data units (SDU) 703-1, 703-2, . . . , and 703-n. A size of the MAC SDU 703-1, 703-2, . . . , and 703-n may be variable. Also, if necessary, the MAC payload may further comprise a padding 704. The MAC PDU sub-header 701-2, 701-3, . . . , 701-(n+1), and 701-(n+2) included in the MAC header 701 may correspond to the MAC SDU 703-1, 703-2, . . . , and 703-n and the padding 704 included in the MAC payload. For example, an order of MAC PDU sub-header 701-2, 701-3, . . . , 701-(n+1), and 701-(n+2) may be identical to an order of the MAC SDU 703-1, 703-2, . . . , and 703-n and the padding 704.

The SL-SCH sub-header 701-1 may comprise a version field 801, a reserved field 802, a source address field 803, and a destination address field 804. The SL-SCH sub-header 701-1 may have a size of 6 octets. The version field 801 may have a size of 4 bits, and indicate version information of a SL-SCH. The reserved field 802 may have a size of 4 bits. The source address field 803 may have a size of 3 octets, and indicate a terminal transmitting the frame 700. Also, the destination address field may have a size of 2 octets, and indicate a terminal receiving the frame 700.

The MAC PDU sub-headers 701-2, 701-3, . . . , 701-(n+1), and 701-(n+2) may be configured as a ‘R/R/E/LCID/F/L’ format or a ‘R/R/E/LCID’ format. The MAC PDU sub-headers 701-2, 701-3, . . . , and 701-(n+1) except for the MAC PDU sub-header 701-(n+2) corresponding to the padding 704 among the MAC PDU sub-headers 701-2, 701-3, . . . , 701-(n+1), and 701-(n+2) may be configured as the ‘R/R/E/LCID/F/L’ format. The MAC PDU sub-headers except for last MAC PDU sub-header 701-(n+1) among the MAC PDU sub-headers having the ‘R/R/E/LCID/F/L’ format may include a reserved field 901, an extension field 902, a logical channel identity (LCID) field 903, a format field 904, and a length field 905 having a size of 7 bits.

The reserved field 901 may have a size of 2 bits. The extension field 902 may have a size of 1 bit, and include a flag indicating whether an additional field exists in the MAC header 701 or not. The LCID field 903 may have a size of 5 bits, and indicate a LCID of the MAC SDU corresponding to the MAC PDU sub-header including the LCID field 903. The format field 904 may indicate a size of the length field 905. The length field 905 may indicate a length of the MAC SDU corresponding to the MAC PDU sub-header including the length field 905.

The last MAC PDU sub-header 701-(n+1) among the MAC PDU sub-headers having the ‘R/R/E/LCID/F/L’ format may include a reserved field 1001, an extension field 1002, a LCID field 1003, a format field 1004, and a length field 1005 having a size of 15 bits. A difference between the last MAC PDU sub-header 701-(n+1) and above-described MAC PDU sub-header is a size of the length field 1005. The reserved field 1001 may have a size of 2 bits. The extension field 1002 may have a size of 1 bit, and include a flag indicating whether an additional field exists in the MAC header 701 or not. The LCID field 1003 may have a size of 5 bits, and indicate a LCID of the MAC SDU corresponding to the MAC PDU sub-header including the LCID field 1003. The format field 1004 may indicate a size of the length field 1005. The length field 1005 may indicate a length of the MAC SDU corresponding to the MAC PDU sub-header including the length field 1005.

The MAC PDU sub-header 701-(n+2) corresponding to the padding 704 among the MAC PDU sub-headers 701-2, 701-3, . . . , 701-(n+1), and 701-(n+2) may be configured as the ‘R/R/E/LCID’ format. The MAC PDU sub-header 701-(n+2) may include a reserved field 1101, an extension field 1102, and a LCID field 1103. The reserved field 1101 may have a size of 2 bits. The extension field 1102 may have a size of 1 bit, and include a flag indicating whether an additional field exists in the MAC header 701 or not. The LCID field 1103 may have a size of 5 bits, and indicate a LCID of the padding 704 corresponding to the MAC PDU sub-header including the LCID field 1003.

Re-referring to FIG. 6, in order to perform D2D communications, the UE1 may configure its identifier (ID) (S600). In a case that the ID of the UE1 is not preconfigured by a higher layer (e.g., a base station, a communication network, or a communication system), the UE1 may directly configure its ID. Also, in a case that the ID configured by the higher layer is not a globally unique ID, the UE1 may directly configure its ID. For example, if the ID configured by the network is a locally unique ID, terminals using the same ID may exist around the UE1. Thus, in these cases, the UE1 may directly configure the ID of itself.

Also, the UE1 may configure its ID in consideration of IDs used by other terminals. For example, the UE1 may obtain frames transmitted from other terminals, and identify source addresses and destination addresses included in the received frames. Then, the UE1 may generate a list comprising source addresses and destination addresses used by other terminals. When the UE1 configures the ID of itself, the UE1 may configure its ID as a value different from IDs included in the list.

The ID may be a layer-2 ID, and the ID can be used as at least one of a source address and a destination address.

FIG. 12 is a conceptual diagram illustrating IDs used in a communication network.

Referring to FIG. 12, a source layer-2 ID, a destination layer-2 ID, and a layer-1 ID may be defined. The source layer-2 ID may be a layer-2 ID configured as a source address. A destination address having a size of 24 bits may consist of a destination layer-2 ID having a size of 16 bits and a layer-1 ID having a size of 8 bits (e.g., SC layer-1 ID).

The source address and destination address may be configured by a higher layer. The source address may have a length of 24 bits, and be included in the sub-header of the frame 700. The destination address may have a length of 24 bits. Among the destination address, 16 bits from a most significant bit (MSB) to 16^{th} bit may be configured as a layer-2 ID, and be included in the sub-header of the frame 700. The layer-2 ID configured based on the destination address may be used for identifying or filtering a MAC frame. Among the destination address, 8 bits from 17^{th} bit to a least significant bit (LSB) may be configured as a layer-1 ID, and be included in the preamble of the frame 700. The layer-1 ID configured based on the destination address may be used for identifying or filtering a PHY frame. Meanwhile, a layer-2 entity (e.g., a MAC entity, a radio link protocol (RLC) entity, a packet data convergence protocol (PDCP) entity) included in the terminal may be identified by using the layer-2 ID (e.g., the source address, the destination address), the LCID, etc.

Re-referring to FIG. 6, the UE1 may configure its ID for each transmission manner. The transmission manner may be at least one of a unicast transmission, a multicast transmission (e.g., group transmission), a broadcast transmission, etc.

For the unicast transmission, the UE1 may configure its ID as follows. The UE1 may configure a layer-2 ID having a size of 24 bits. The layer-2 ID may be used as a source address or a destination address for the unicast transmission. The UE1 may configure the layer-2 ID without any restriction. In this case, totally 2²⁴ layer-2 IDs are available.

Alternatively, the UE1 may receive ID range information from a higher layer, and configure the layer-2 ID in a range indicated by the ID range information. Since the destination address for the multicast transmission or the broadcast transmission is predetermined (reserved) in advance, the layer-2 ID for the unicast transmission may be configured as a value different from the predetermined destination addresses. Through this, a problem of address collision can be resolved.

The lower 8 bits of the destination address (e.g., the layer-1 ID) may be used for identifying a transmission manner of the corresponding frame. The lower 8 bits of the destination address may be the layer-1 ID. Thus, for the unicast transmission, the lower 8 bits of the destination address may be configured in a range specified in the below table 1 or table 2.

TABLE 1

| Transmission manner | ID |
|---|---|
| Unicast | 0x00~0xEF |
| Multicast | 0xF0~0xFE |
| broadcast | 0xFF |

TABLE 2

| Transmission manner | ID |
|---|---|
| Unicast | 0x00~0xEF |
| Multicast/Broadcast | 0xF0~0xFF |

For example, the UE1 may configure the lower 8 bits of the destination address in the range of 0x00˜0xEF. Alternatively, the UE1 may configure the destination address in the range specified in the below table 3.

TABLE 3

| Transmission manner | ID |
|---|---|
| Unicast | 0x000000~0xF00000 |
| Multicast | 0xF00001~0xFFFFFE |
| broadcast | 0xFFFFFF |

For example, the UE1 may configure the destination address in the range of 0x000000 to 0xF00000. In the case that the destination address is configured like this, the receiving terminal may identify which transmission manner is used for transmission of a received frame only by checking a preamble of the receive frame.

The transmission manner may be classified using a part of the destination address, thereby a problem of address collision between different transmission manners can be resolved. However, address collision may be generated between services or terminals using same transmission manner because a size of address which is allocated to each transmission manner is decreased.

Meanwhile, an address for each transmission manner may not be classified, and the transmission manner may also be indicated by at least one of the version field and the reserved field included in the sub-header. Also, a bit in the reserved field may be used as a PDU indicator for indicating the transmission manner of the frame. In a case that the PDU indicator is configured as ‘0,’ this may indicate that the frame is transmitted in the multicast manner (or, broadcast manner). In a case that the PDU indicator is configured as ‘1,’ this may indicate that the frame is transmitted in the unicast manner. Alternatively, as the PDU indicator for indicating the transmission manner of the frame, two bits of the reserved field may be used. In a case that the PDU indicator is configured as ‘00,’ this may indicate that the frame is transmitted in the multicast manner. In a case that the PDU indicator is configured as ‘01,’ this may indicate that the frame is transmitted in the broadcast manner. In a case that the PDU indicator is configured as ‘10,’ this may indicate that the frame is transmitted in the unicast manner.

Also, the version field may indicate whether the reserved field includes the PDU indicator. In this case, the version field and the reserved field may indicate a data property (e.g., a quality of service (QoS) of data transmitted through SL-SCH, a PDU type, a transmission manner, etc.) or a format of the data (e.g., a format of the sub-header transmitted through SL-SCH). Each bit of the version field may indicate specific information. For example, the first bit of the version field may indicate whether the PDU indicator exists in the sub-header (e.g., in the reserved field). The version field configured as ‘1000’ may indicate that the PDU indicator exists in the sub-header. On the contrary, the version field configured as ‘0110’ or ‘0001’ may indicate that the PDU indicator does not exist in the sub-header. Alternatively, a specific configuration of the version field may indicate whether the PDU indicator exists in the sub-header (e.g., in the reserved field). For example, the version field configured as ‘0011,’ ‘0101,’ or ‘1101’ may indicate that the PDU indicator exists in the sub-header (e.g., in the reserved field).

As another example, the transmission manner may be indicated by the LCID. The LCID for SL-SCH may be represented as shown in the below table 4.

TABLE 4

| Index | LCID value |
|---|---|
| 00000 | Reserved |
| 00001~01010 | ID of logical channel |
| 01011~10100 | ID of logical channel for unicast |
| 10101~11110 | Reserved |
| 11111 | Padding |

‘00000’ may be used for indicating the unicast transmission. Alternatively, a specific index (e.g., ‘01011’) or a specific index range (e.g., ‘01011’ to ‘10100’ or ‘10101’ to ‘11110’) may indicate the unicast transmission. Multiple LCIDs may be configured for indicating the unicast transmission. Through this, transmissions according to traffic priorities or QoS can be possible for the unicast transmission.

On the other hand, for the multicast transmission, the UE1 may configure its ID as follows. A layer-2 ID to be used as a source address for the multicast transmission may be directly configured by the UE1 or may be configured by the system. The layer-2 ID may be configured regardless of the transmission manner, thereby the layer-2 ID having a size of 24 bits may be configured.

For the broadcast transmission, the UE1 may configure its ID as follows. A layer-2 ID used as a source address for the broadcast transmission may be directly configured by the UE1 or may be configured by the system. The layer-2 ID may be configured regardless of the transmission manner, thereby the layer-2 ID having a size of 24 bits may be configured. The configuration manner of the ID of the UE1 is not restricted to the above-described manner, and the ID of the UE1 may be configured in various manners.

The UE1 may transmit a frame by using the IDs configured in the above-described manner (S610). For unicast transmission, the UE1 may configure its layer-2 ID as a source address, and configure a layer-2 ID of the UE2 as a destination address. Also, the layer-1 ID of the UE2 may be configured in the preamble of the frame. The UE1 may transmit the frame to the UE2 in unicast manner. The UE2 may identify the transmission manner of the received frame based on the information (e.g., the layer-1 ID included in the preamble, the PDU indicator, the layer-2 ID, the LCID, etc. included in the MAC header) included in the frame received from the UE1. Therefore, the UE2 can identify that the received frame has been transmitted in unicast manner, and decode fields subsequent to the MAC header when the destination address configured in the MAC header is identical to the ID of the UE2 (e.g., the layer-2 ID).

For multicast transmission, the UE1 may configure its layer-2 ID as a source address of a frame to be transmitted, and configure a predetermined ID (e.g., a multicast ID, a group ID, etc.) as a destination address of the frame. Also, a layer-1 ID for the multicast transmission may be configured in a preamble of the frame. The UE1 may transmit the frame in multicast transmission manner. The UE2 may identify the transmission manner of a received frame based on information (e.g., the layer-1 ID included in the preamble, the PDU indicator, the layer-2 ID, the LCID, etc. included in the MAC header) included in the received frame. Therefore, the UE2 may identify that the received frame has been transmitted in multicast manner, and decode fields subsequent to the MAC header when the UE2 belongs to a group indicated by the destination address configured in the MAC header.

For broadcast transmission, the UE1 may configure its layer-2 ID as a source address of a frame to be transmitted, and configure a predetermined ID (e.g., a broadcast ID, etc.) as a destination address of the frame. Also, a layer-1 ID for the broadcast transmission may be configured in a preamble of the frame. The UE1 may transmit the frame in broadcast transmission manner. The UE2 may identify the transmission manner of a received frame based on information (e.g., the layer-1 ID included in the preamble, the PDU indicator, the layer-2 ID, the LCID, etc. included in the MAC header) included in the received frame. Therefore, the UE2 may identify that the received frame has been transmitted in broadcast manner, and decode fields subsequent to the MAC header.

Hereinafter, methods for identifying an ID of an opposite terminal with which D2D communications are performed will be described. In a case that an ID is configured in advance by a higher layer for unicast transmission (or, multicast transmission or broadcast transmission), since a terminal can obtain the ID of the opposite terminal from the higher layer, an additional procedure for obtaining the ID of the opposite terminal is not necessary. However, in a case that the opposite terminal configures its ID directly, methods for obtaining the ID of the opposite terminal are required.

FIG. 13 is a sequence chart illustrating a method of obtaining an ID of a terminal according to an exemplary embodiment of the present disclosure.

Referring to FIG. 13, the UE1 may be located in a communication range with the UE2. That is, the UE1 can perform D2D communications with the UE2. The UE1 may be the first terminal 110 explained by referring to FIGS. 1 to 4. The UE2 may be the second terminal 210 explained by referring to FIGS. 1 to 4. Also, each of the UE1 and the UE2 may be configured identically to the communication node 500 explained by referring to FIG. 5.

The UE1 may notify its ID periodically or aperiodically. Here, the ID may be the layer-2 ID explained by referring to FIG. 6, and the layer-2 ID may be used for unicast transmission. For example, the UE1 may generate a discovery frame including its layer-2 ID. Also, the discovery frame may include a user code for each application (or, each service) supported by the UE1. The user code may be configured by a higher layer, and the UE1 may have a plurality of user codes each of which corresponds to each application. For example, the discovery frame may include a ProSe ID of the UE1. The UE1 may transmit the discovery frame in broadcast manner (S 1300). The discovery frame may be transmitted transparently in an access stratum (AS) level, and the discovery frame may not include a MAC sub-header. The discovery frame may be transmitted through a predetermined physical channel.

The UE2 may receive the discovery frame from the UE1, and obtain the layer-2 ID and the ProSe ID of the UE1 which are included in the discovery frame (S1310). For example, the UE2 may obtain the layer-2 ID and Prose ID of the UE1 through ProSe discovery. In a case that the UE2 wants to perform D2D communications with the UE1, the UE2 may configure a unicast session and a security with the UE1 (S1320). A frame used for configuring the unicast session and the security may be transmitted in unicast manner. For example, the UE2 may configure its layer-2 ID as a source address of the frame, configure the obtained layer-2 ID of the UE1 as a destination address of the frame, and perform configuration of the unicast session and the security by transmitting the frame. After the configuration of the unicast session and the security is completed, D2D communications between the UE1 and the UE2 may be performed (S1330).

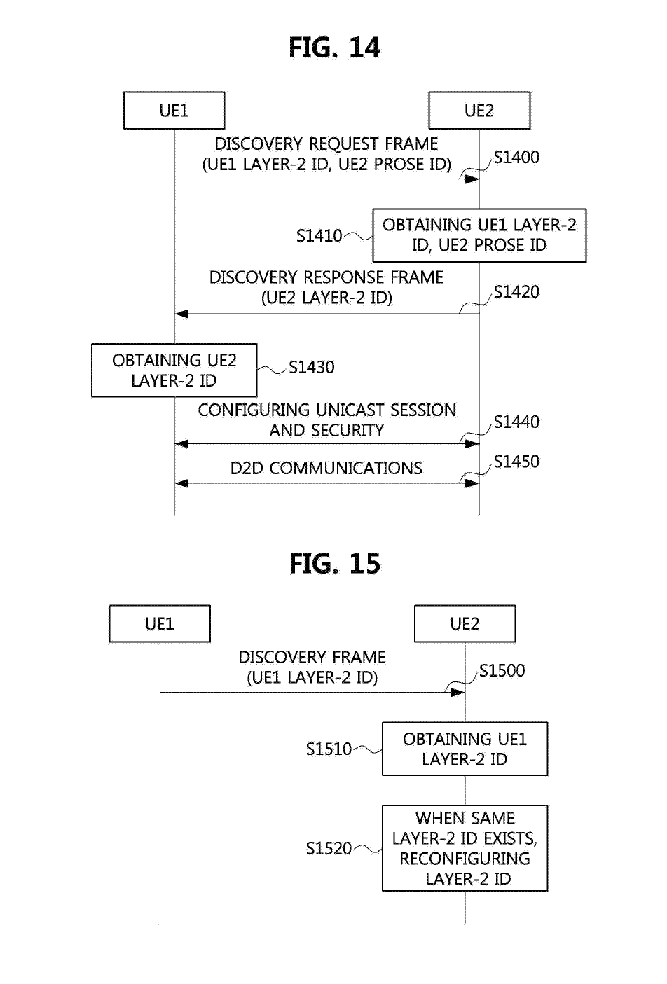

FIG. 14 is a sequence chart illustrating a method of obtaining an ID of a terminal according to another exemplary embodiment of the present disclosure.

Referring to FIG. 14, the UE1 may be located in a communication range with the

UE2. That is, the UE1 can perform D2D communications with the UE2. The UE1 may be the first terminal 110 explained by referring to FIGS. 1 to 4. The UE2 may be the second terminal 210 explained by referring to FIGS. 1 to 4. Also, each of the UE1 and the UE2 may be configured identically to the communication node 500 explained by referring to FIG. 5.

In a case that the UE1 wants to perform D2D communications with an opposite terminal (e.g., the UE2), the UE1 may request an ID of the opposite terminal (e.g., the UE2). Here, the ID of the UE2 may be the layer-2 ID explained by referring to FIG. 6, and the layer-2 ID may be used for unicast transmission. For example, the UE1 may generate a discovery request frame requesting the ID of the opposite terminal. The discovery request frame may further include the layer-2 ID of the UE1 and a ProSe ID of the opposite terminal. For example, an ID of the opposite terminal which corresponds to the ProSe ID may be requested by the discovery request frame. The UE1 may transmit the discovery request frame (S1400). The discovery request frame may be transmitted transparently in the AS level, and the discovery request frame may not include a MAC sub-header. The discovery request frame may be transmitted through a predetermined physical channel.

The UE2 may receive the discovery request frame from the UE1, and obtain the layer-2 ID of the UE1 and the ProSe ID which are included in the discovery request frame (S1410). In a case that the UE2 supports a service indicated by the ProSe ID included in the discovery request frame, the UE2 may generate a discovery response frame including the layer-2 ID of the UE2, and transmit the discovery response frame to the UE1 (S1420). The discovery response frame may be transmitted transparently in the AS level, and the discovery response frame may not include a MAC sub-header. The discovery response frame may be transmitted through a predetermined physical channel. The UE1 may receive the discovery response frame from the UE2 in response to the discovery request frame, and obtain the layer-2 ID of the UE2 from the discovery response frame (S1430).

In the case that the UE1 wants to perform D2D communications with the UE2, the UE1 may configure a unicast session and a security with the UE2 (S1440). A frame used for configuring the unicast session and the security may be transmitted in unicast manner. For example, the UE1 may configure its layer-2 ID as a source address of the frame, configure the obtained layer-2 ID of the UE2 as a destination address of the frame, and perform configuration of the unicast session and the security by transmitting the frame. After the configuration of the unicast session and the security is completed, D2D communications between the UE1 and the UE2 may be performed (S1450).

Hereinafter, methods for preventing collisions between IDs in D2D communications will be described.

FIG. 15 is a sequence chart illustrating a method of preventing collisions between IDs of terminals according to an exemplary embodiment of the present disclosure.

Referring to FIG. 15, the UE1 may be located in a communication range with the UE2. That is, the UE1 can perform D2D communications with the UE2. The UE1 may be the first terminal 110 explained by referring to FIGS. 1 to 4. The UE2 may be the second terminal 210 explained by referring to FIGS. 1 to 4. Also, each of the UE1 and the UE2 may be configured identically to the communication node 500 explained by referring to FIG. 5.

The UE1 may notify its ID periodically or aperiodically. Here, the ID may be the layer-2 ID explained by referring to FIG. 6, and the layer-2 ID may be used for unicast transmission. For example, the UE1 may generate a discovery frame including its layer-2 ID, and transmit the generated discovery frame in broadcast manner (S1500). The discovery frame may include IDs of other terminals with which the UE1 performs D2D communications (e.g., unicast based D2D communications). The discovery frame may be transmitted with a short periodicity. The discovery frame may be transmitted transparently in the AS level, and may not include a MAC sub-header. The discovery frame may be transmitted through a predetermined physical channel.

The UE2 may receive the discovery frame from the UE1, and obtain the layer-2 ID of the UE1 from the discovery frame (S1510). When the layer-2 ID of the UE2 is identical to the layer-2 ID of the UE1, the UE2 may reconfigure its layer-2 ID (S1520). For example, the UE2 may inform the higher layer of that the layer-2 IDs of the UE2 and UE1 are same, and obtain a reconfigured layer-2 ID from the higher layer. Alternatively, the UE2 may directly reconfigure its layer-2 ID based on the methods explained by referring to FIG. 6. In a case that the UE2 cannot reconfigure its layer-2 ID, the UE2 may notify the UE1 that the same layer-2 IDs are being used.

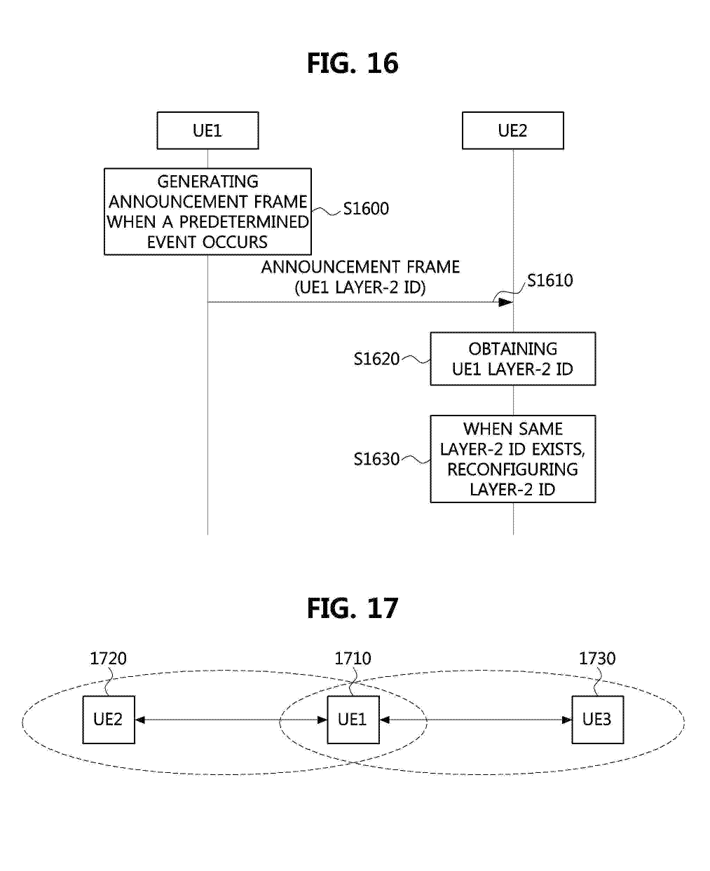

FIG. 16 is a sequence chart illustrating a method of preventing collisions between IDs of terminals according to another exemplary embodiment of the present disclosure.

Referring to FIG. 16, the UE1 may be located in a communication range with the UE2. That is, the UE1 can perform D2D communications with the UE2. The UE1 may be the first terminal 110 explained by referring to FIGS. 1 to 4. The UE2 may be the second terminal 210 explained by referring to FIGS. 1 to 4. Also, each of the UE1 and the UE2 may be configured identically to the communication node 500 explained by referring to FIG. 5.

The UE1 may generate an announcement frame when a predetermined event occurs as follows (S1600). The announcement frame may be configured by a radio resource control (RRC) entity or a non-AS (NAS). Alternatively, the announcement frame may be configured by a MAC entity.

(Event-1) A case that the layer-2 ID of the UE1 is configured initially (for example, a case that the layer-2 ID of the UE1 is configured initially after configuration for D2D communications is completed).

(Event-2) A case that the UE1 has not transmitted a frame (e.g., a frame whose source address is set to the layer-2 ID of the UE1) for a predetermined time (e.g., a packet inactivity time). If the UE1 moves for the predetermined time, terminals using the same layer-2 ID may exist around the UE1. Thus, after the predetermined time is expired, the announcement frame may be generated in order to prevent latent collisions between IDs.

(Event-3) A case that an address of a frame received from other terminal is identical to the layer-2 ID of the UE1. Here, in a case that the frame has been transmitted in unicast or broadcast manner, the announcement frame may be generated when the address of the frame is identical to the layer-2 ID of the UE1. In a case that the frame has been transmitted in multicast manner, the announcement frame may be generated when the UE1 belongs to a group indicated by a group ID of the frame and the source address (e.g., the group member ID) of the frame is identical to the layer-2 ID of the UE1.

The announcement frame may include information elements listed in the below table 5.

TABLE 5

| Information Element | Description |
|---|---|
| Frame Type Indicator | Indicating that the address information is being |
| | announced. |
| Transmission Manner | Indicating unicast, multicast, or broadcast |
| Indicator | |
| Source Address | Layer-2 ID of the UE1 |
| Destination Address | Unicast: all zero |
| | Multicast: group ID |
| | Broadcast: broadcast ID |

In the case that the announcement frame is transmitted in unicast manner, the destination address of the announcement frame may be set to all zero. In the case that the announcement frame is transmitted in multicast manner, the destination address of the announcement frame may be set to a group ID (or, multicast ID). In the case that the announcement frame is transmitted in broadcast manner, the destination address of the announcement frame may be set to a broadcast ID. Also, the announcement frame may include IDs of other terminals with which the UE1 performs D2D communications (e.g., unicast based D2D communications).

The UE1 may transmit the announcement frame (S1610). The UE2 may receive the announcement frame from the UE1, and obtain the layer-2 ID of the UE1 from the announcement frame (S1620). The UE2 may determine whether the layer-2 ID of the UE2 is identical to the layer-2 ID of the UE1, and reconfigure the layer-2 ID of the UE2 when they are identical to each other (S1630). In this case, the UE2 may reconfigure its layer-2 ID based on the methods explained by referring to FIG. 6. Alternatively, the UE2 may inform the higher layer of that the layer-2 IDs of the UE1 and UE2 are same, and obtain a reconfigured layer-2 ID from the higher layer. In a case that the UE2 cannot reconfigure its layer-2 ID, the UE2 may notify the UE1 that the same layer-2 IDs are being used.

On the other hand, in a wireless communication network, each terminal may configure its ID without consideration of IDs of other terminals. In this case, IDs of the terminals may be identical to each other.

FIG. 17 is a conceptual diagram illustrating another exemplary embodiment of a communication network.

Referring to FIG. 17, terminals 1710, 1720, and 1730 may perform D2D communications. The first terminal 1710 may be located in a communication range with the second terminal 1720 and the third terminal 1730. The second terminal 1720 may be located out of a communication range with the third terminal 1730. Each of the terminals 1710, 1720, and 1730 may configure its ID according to the method explained by referring to FIG. 6. For example, the first terminal 1710 may configure its ID as ‘A,’ and the second terminal 1720 and the third terminal 1730 may configure their IDs as ‘B.’

Each of the second terminal 1720 and the third terminal 1730 may transmit a frame whose a source address is set to ‘B’ to the first terminal 1710. In this case, the first terminal cannot receive the frame from the second terminal 1720 and the third terminal 1730 successfully. For example, due to errors in sequence numbers, errors in segmentation and concatenations, etc., the first terminal 1710 cannot successfully receive the frames from two terminals. Therefore, methods for resolving the above problem are demanded.

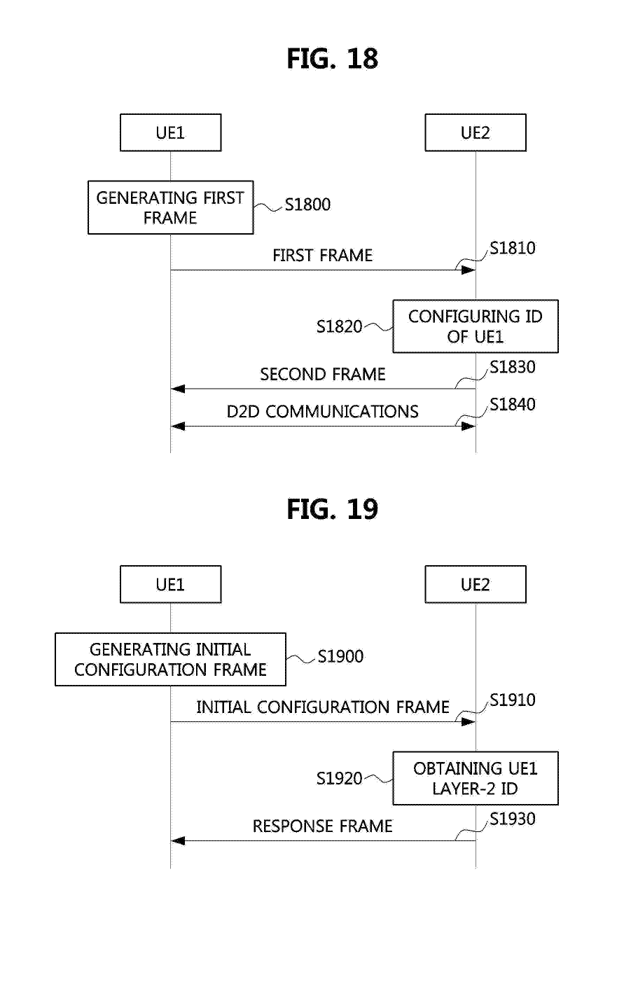

FIG. 18 is a sequence chart illustrating a method of preventing collisions between IDs of terminals according to yet another exemplary embodiment of the present disclosure.

Referring to FIG. 18, the UE1 may be located in a communication range with the UE2. That is, the UE1 can perform D2D communications with the UE2. The UE1 may be the first terminal 110 explained by referring to FIGS. 1 to 4. The UE2 may be the second terminal 210 explained by referring to FIGS. 1 to 4. Also, each of the UE1 and the UE2 may be configured identically to the communication node 500 explained by referring to FIG. 5. When the D2D communications are performed, the UE1 and the UE2 may exchange frames with each other. Here, the frames may have the same structure as the frame 700 explained by referring to FIG. 7 and FIG. 8.

The UE1 may generate a first frame requesting configuration of its ID (S1800). A source address of the first frame may be configured as a predetermined value. For example, the source address of the first frame may be configured as all zero. A destination address of the first frame may be set to the ID (e.g., the layer-2 ID) of the UE2. Here, the UE1 may identify the ID of the UE2 by obtaining a frame transmitted by the UE2, or by obtaining the ID of the UE2 from the higher layer. Also, the UE1 may configure at least one candidate ID of the UE1, and the candidate ID may be included in the first frame.

The first frame may be a frame requesting to configure a connection for D2D communications. The first frame may include configuration information for unicast transmission. The configuration information may include MAC-related configuration parameters, RLC-related configuration parameters, PDCP-related configuration parameters, etc. Also, the first frame may further include a LCID configured by the UE1. The UE1 may transmit the first frame to the UE2 (S1810).

The UE2 may receive the first frame from the UE1, and be informed of that the ID and the connection configuration for the D2D communications with the UE1 have been requested based on the first frame. For example, in a case that the source address of the first frame is set to a predetermined value, the UE2 may identify that the configuration of the ID for D2D communications has been requested.

The UE2 may configure an ID of the UE1 (S1820). In this instance, the UE2 may configure the ID of the UE1 in a range predetermined for each transmission manner (e.g., the ranges described in the tables 1 to 3). Also, in a case that at least one candidate ID is included in the first frame, the UE2 may determine one of the at least one candidate ID as the ID of the UE1. The UE2 may configure the ID of the UE1 differently from IDs used by terminals located in a communication range with the UE2. Also, when the first frame does not include a LCID, the UE2 may configure a LCID for D2D communications with the UE1.

The UE2 may generate a second frame including the ID of the UE1. The second frame may further include the LCID configured by the UE2. The UE2 may transmit the second frame to the UE1 (S1830). The UE1 may receive the second frame from the UE2, and obtain its ID from the received second frame. The UE1 may perform configuration procedures of a session (e.g., a unicast session) and a security for the D2D communications with the UE2 by using the ID configured by the UE2. Also, the UE2 may allocate an internet protocol (IP) address for the UE1. After the configuration procedures of the session and the security are completed, the D2D communications between the UE1 and the UE2 may be performed (S1840).

FIG. 19 is a sequence chart illustrating a method of preventing collisions between IDs of terminals according to yet another exemplary embodiment of the present disclosure.

Referring to FIG. 19, the UE1 may be located in a communication range with the UE2. That is, the UE1 can perform D2D communications with the UE2. The UE1 may be the first terminal 110 explained by referring to FIGS. 1 to 4. The UE2 may be the second terminal 210 explained by referring to FIGS. 1 to 4. Also, each of the UE1 and the UE2 may be configured identically to the communication node 500 explained by referring to FIG. 5.

The UE1 wanting to perform D2D communications with the UE1 may generate an initial configuration frame (S1900). The initial configuration frame may include the ID of the UE1 (e.g., the layer-2 ID). Also, the initial configuration frame may further include a LCID for unicast transmission, and the LCID may be configured in the range described in the table 4. The UE1 may transmit the initial configuration frame to the UE2 (S1910). The initial configuration frame may be transmitted through a bearer to which a security is not applied.

The UE2 may receive the initial configuration frame from the UE1, and obtain the ID of the UE1 from the initial configuration frame (S1920). In a case that the UE2 is performing D2D communications with other terminals, the UE2 may determine whether the ID of the UE1 is identical to IDs of other terminals with which the UE2 is performing D2D communications. If the ID of the UE1 is identical to at least one of the IDs of other terminals with which the UE2 is performing D2D communication, the UE2 may inform the UE1 of that the same ID is used by at least one other terminal by transmitting a response frame to the UE1 (S1930). The response frame may include the ID used by the at least one other terminal with which the UE2 is performing D2D communications. The response frame may be transmitted in broadcast manner.

The UE1 may receive the response frame from the UE2, and identify that the ID of the UE1 is identical to the ID of other terminal based on the response frame. Also, the UE1 may identify the ID of other terminal with which the UE2 is performing D2D communications. In this case, the UE1 may directly reconfigure its ID based on the methods explained by referring to FIG. 6. Alternatively, the UE1 may inform the higher layer of that the layer-2 IDs of the UE1 and UE2 are same, and obtain a reconfigured layer-2 ID from the higher layer.

On the contrary, in a cast that the ID of the UE1 is different from IDs of terminal with which the UE2 is performing D2D communications, the UE2 may inform the UE1 of that the ID of the UE1 is not used by other terminal by transmitting the response frame to the UE1 (S1930). The response frame may include the IDs of the terminals with which the UE2 is performing D2D communications. The response frame may be transmitted in broadcast manner.

The UE1 may receive the response frame from the UE2, and identify that the ID of the UE1 is not used by other terminals based on the response frame. Also, the UE1 may identify IDs of other terminals with which the UE2 is performing D2D communications based on the response frame. The UE1 may configure a secured connection with the UE2, and perform D2D communications through the secured connection.

Meanwhile, the D2D communications may be performed based on priorities. For the D2D communications, priorities for respective bearers may be configured, and the terminal may transmit a bearer having a higher priority earlier than a bearer having a lower priority. The priorities may be configured by the terminal (e.g., an application layer included in the terminal), a base station, or a network, and the priority information indicating configured priority may be transmitted from the application layer to the MAC layer. In the MAC layer, the priority may be mapped onto a LCID and a logical channel group identity (LCGID) to which the LCDI belongs. The mapping information (e.g., ‘priority-LCID,’ ‘priority-LCGID’) may be configured by a terminal or a base station, and configured statically or dynamically.

In the case that the mapping information is configured by the terminal, the terminal may obtain information on a priority of a generated traffic from the higher layer when the traffic is generated, configure a LCID corresponding to the priority, and determine a LCGID to which the LCID belongs. When the D2D communications are supported by the base station, the terminal may transmit the mapping information to the base station. The terminal may transmit the traffic based on the priority information and the mapping information.

In the case that the mapping information is configured by the base station, the base station may configure a priority of a traffic, or obtain a priority information of the traffic from the network. The base station may configure a LCID and LCGID mapped to the priority. The base station may transmit the priority information and the mapping information (e.g., ‘priority-LCID,’ ‘priority-LCGID’) in unicast manner or broadcast manner. For example, the base station may transmit the mapping information to the terminal through dedicated signaling. In this case, the terminals locating in a coverage of the base station may have the same priority regardless of their RRC modes.

Meanwhile, in the transmission based on priorities, since the terminal may directly allocate resources in RRC idle mode, the terminal may first transmit the traffic for the terminal having a higher priority. On the contrary, in a case that the base station allocates resources, the terminal may request resources to the base station by using the LCGID. The LCGID may be configured to have a length of 2 bits. However, if priorities more than four are defined, LCIDs more than four may be supported.

In the case that the base station allocates resources for D2D communications, the terminal may report a buffer status to the base station via a buffer status report (BSR). Through the BSR, a buffer size for each group and a buffer size for each LCGID may be reported. Terminal related to unicast transmission may be grouped into a single group. If the number of priorities is same as the number of LCIDs, four LCGIDs may be supported.

In the case that the base station allocates resources, four LCGIDs may be supported. The mapping between LCGIDs and priorities may be performed by the terminal or the base station. Through the BSR, indexes of four LCIDs having higher priorities for each group, not four LCGIDs, may be reported. Through the BSR, a buffer size for each group, a buffer size for each LCID, and a buffer size for each LCGID may be reported.

The methods according to embodiments of the present invention may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present invention or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the operation of the present invention, and vice versa.

According to an embodiment of the present invention, it is possible to easily determine a state (that is, a normal state or a fault state) of each of communication nodes constituting a vehicle network and a state of a channel (or port) to which the communication node is connected. A communication node and channel in a fault state may be quickly repaired based on the determination result. Thus the performance of the vehicle network may be enhanced.

While the example embodiments of the present invention and their advantages have been described in detail, it should be understood that various changes, substitutions and alterations may be made herein without departing from the scope of the invention.

What is claimed is:

1. An operation method of a terminal in a communication network, the method comprising:
configuring a layer-2 ID of the terminal which is used in device-to-device (D2D) communications according to a transmission manner; and
performing the D2D communications by using the layer-2 ID.

2. The method according to claim 1, wherein, when the transmission manner is a unicast transmission, the layer-2 ID is used as a source address and a destination address.

3. The method according to claim 1, wherein the layer-2 ID has a size of 24 bits.

4. The method according to claim 1, wherein, when the transmission manner is a multicast transmission, the layer-2 ID is used as a source address, and a predetermined multicast ID is used as a destination address.

5. The method according to claim 1, wherein, when the transmission manner is a broadcast transmission, the layer-2 ID is used as a source address, and a predetermined broadcast ID is used as a destination address.

6. The method according to claim 1, wherein the layer-2 ID is configured within a range determined according to the transmission manner.

7. The method according to claim 1, wherein a frame transmitted from the terminal in the D2D communications includes an indicator indicating the transmission manner of the frame.

8. The method according to claim 7, wherein the indicator is a layer-1 ID, and the layer-1 ID is included in a preamble of the frame.

9. The method according to claim 7, wherein the indicator is a logical channel identity (LCID), and the LCID is configured according to the transmission manner of the frame.

10. The method according to claim 7, wherein the indicator is included in a medium access control (MAC) header of the frame.

11. The method according to claim 10, wherein the MAC header further includes information indicating whether the indicator exists in the MAC header or not.

12. The method according to claim 1, wherein the method further comprises receiving a mapping information between a priority of traffic and a logical channel group identity (LCGID) from a base station.

13. The method according to claim 12, wherein the mapping information is received through dedicated signaling.

14. An operation method of a first terminal in a communication network, the method comprising:
receiving a frame including a layer-2 ID of a second terminal from the second terminal;
configuring a session for device-to-device (D2D) communications by using the layer-2 ID of the second terminal; and
performing the D2D communications with the second terminal through the session.

15. The method according to claim 14, wherein the layer-2 ID is configured for unicast based D2D communications, and the layer-2 ID is used as a source address and a destination address.

16. The method according to claim 14, wherein the frame further includes an indicator indicating at least one service supported by the second terminal.

17. An operation method of a first terminal in a communication network, the method comprising:
transmitting a first frame including a layer-2 ID of the first terminal and an indicator indicating at least one service supported by the first terminal;
receiving a second frame including a layer-2 ID of a second terminal from the second terminal, in response to the first frame;
configuring a session for device-to-device (D2D) communications by using the layer-2 ID of the second terminal; and
performing the D2D communications with the second terminal through the session.

18. The method according to claim 17, wherein the second terminal supports the at least one service indicated by the indicator.

19. The method according to claim 17, wherein the layer-2 ID is configured for unicast based D2D communications, and the layer-2 ID is used as a source address and a destination address.

20. The method according to claim 17, wherein the method further comprises reconfiguring the layer-2 ID of the first terminal when the second frame indicates that the layer-2 ID of the first terminal is used by another terminal.
